(19) United States
(12) Patent Application Publication
(10) Pub. No.: US 2002/0155415 A1
(43) Pub. Date: Oct. 24, 2002

(54) Amusement area devoted and structured for skilled maneuvering of a vehicle

(76) Inventor: Douglas M. Carr, Delta, OH (US)

Correspondence Address: George R. Royer, Suite 416, 316 N. Michigan Street, Toledo, OH, 43624, US

(21) Appl. No.: 09/841,558

(22) Filed: Apr. 24, 2001

(51) Int. Cl. G09B 9/04

(52) U.S. Cl. 434/65

(57) ABSTRACT

The subject invention comprises an area that is structured to hold one or more obstacles zones for the maneuvering of motor vehicles through an obstacle or series of obstacles, all requiring skill in the operation of a particular vehicle, with the obstacle zones having a plurality of contact members that are intended to be avoided by the vehicle operator while driving through a particular obstacle zone, which contact members are adapted to sense a vehicle impact that are capable of registering such contact or contacts in order that a score can be attributed to a given rider's relative skill in the drive through such obstacle course.

### C. KNOWN PRIOR ART

None.

### D. DISCUSSION OF PRIOR ART AND BACKGROUND OF INVENTION

The invention herein is centered on a park area that is structured to comprise a plurality of obstacle areas or zones that are to be traversed in a vehicular movement in a controlled manner over a series of courses. The driver of the vehicle in this park area is required to combine driving skills involving turns, climbs, hazards, and other obstacles, and in the process movement utilizes certain driving skills, however, with the difference that negative points are accumulated for contacting stationary members in a given obstacle zone. Other scoring techniques may be used in this respect.

There are no known park areas having such obstacle zones for vehicles that adopt a function with the purpose that would be to produce areas of roadways with the foregoing features and the following objects of the subject invention are directed accordingly.

It is a further purpose of this invention to provide an amusement area where drivers or operators of any type of vehicles can maneuver their vehicles for recreational purposes is a manner that is not in specifically permitted over public highways. The purposes in this regard is to permit a driver to test the limits of his driving skill as well as the limits of a vehicle. This invention sets forth a novel approach to such activities and the objects herein as set forth below.

### E. OBJECTS OF THE INVENTION

It is an object of the subject invention to provide a novel park area for drivers to maneuver motor vehicles through one or more obstacle zones for scoring or non-scoring purposes;

Another object of the subject invention is to provide an improved amusement area that requires motor vehicle driving skills on the part of the driver and includes scoring means for the relative skill maneuvering in an obstacle area;

Still another obstacle is to provide an amusement area devoted mainly to motor vehicle operation for skill purposes;

It is also an object of the subject invention to provide an area, with a plurality of driving obstacles, where the driver can test his or her driving skills on various obstacles;

Yet another object of the subject invention is to provide an area devoted to motor vehicle obstacles for testing driving skills;

Other and further objects of the subject invention will be apparent from a reading taken in conjunction with the claims.

Further objects of the subject invention are to provide zones for operation of motor vehicles for training individuals in motor vehicle operations through varying obstacle zones.

### F. BRIEF DESCRIPTION OF DRAWINGS

FIG. 1 is a top elevational view of the preferred embodiment of a park area incorporating features of the subject invention;

FIG. 2 is a top elevational view of one embodiment of an obstacle zone used in conjunction with the subject park;

FIG. 3 is a top elevational view of yet another embodiment of an obstacle zone to be used in the park area incorporating features described in this application;

FIG. 4 is a top elevational view of still another obstacle zone used in conjunction with the subject invention;

FIG. 5 is a top elevational view of a bumper obstacle used in conjunction with the subject invention, showing moving contact by a vehicle;

FIG. 6 is a side elevational view in section of a contact member and the vertical moveable post used to sense and register an impact against a bumper obstacles as shown in FIG. 5.

FIG. 7 is a top elevational view of an additional embodiment of an obstacle zone.

### G. DESCRIPTION OF GENERAL EMBODIMENT AND SUMMARY OF INVENTION

The subject invention comprises an area that is structured to hold one or more obstacles zones for the maneuvering of motor vehicles through an obstacle or series of obstacles, all requiring skill in the operation of a particular vehicle, with the obstacle zones having a plurality of contact members that are intended to be avoided by the vehicle operator while driving through a particular obstacle zone, which contact members are adapted to sense a vehicle impact and are capable of registering such contact or contacts in order that a score can be attributed to a given rider's relative skill in the drive through such obstacle course, such scoring being a functional representation of the relative skill of a driver as to a specific obstacle zone.

In further summary, the subject invention is focused on a theme park centered on operation of motor vehicles under conditions where the driver's skill is tested over various driving courses and where the driver's skill is tested and scored through electronically activated means which are then optionally computer correlated and tabulated. The scoring results calculated through computer means, are then set forth for comparison purposes to ascertain relative scoring between drivers or contestant drivers.

For purposes of accomplishing these objectives, each individual obstacle portion of the overall course is equipped with devices that are sensitive to physical contact by a motor vehicle as it is driven and navigated through the course.

In some instances, a particular course that is to be navigated by the driver may have strategically placed sensitive devices that will sense any touching or impact by a motor vehicle as it traverses through the obstacle.

These sensitive devices may be physical members that upon impact are moved in a predetermined direction, such as sideways, inwardly, or in any direction, so long as the resultant movement will cause an electromechanical action that, in turn, is converted to a specific electrical tabulator ultimately linked to a computer. Obviously, any impact device will be appropriately structured, with cushioning or other means that will not result in a vehicular damage when the impact occurs. Conversely, the sensing devices will be structured in a flexible manner so that impact will not damage the vehicle. Other physical or electrical means may be used to record and score impacts by a vehicle.

Other obstacles may be structured in a manner where there is manual scoring, photographic sensing device, or other means to ascertain the impact of the vehicle in a given obstacle. Whatever scoring means is used, there will be some ultimate correlation or comparison with other scorings.

It is contemplated that the driver who enters the course will maneuver a vehicle through a number of obstacles for individual scoring in each case. In such event an overall scoring result may be utilized for this purpose.

In a general summarization of the subject invention, it is indicated that the subject invention is focused on an amusement scheme utilizing land-based vehicles of any type, including automobiles, trucks, racers, scooters, bicycles, motor bikes, or other land-based vehicles on a land-based course, including a series of obstacles or other objects which are to be maneuvered over, around, or against for sporting purposes involving driving skills in which the vehicle operator is given points for scoring purposes.

### H. DESCRIPTION OF PREFERRED EMBODIMENT OF THE INVENTION

In describing a preferred embodiment of the subject invention, it is to be stressed that the following description of a preferred embodiment is not to be considered as limiting the scope of the subject invention, as set forth in the claims.

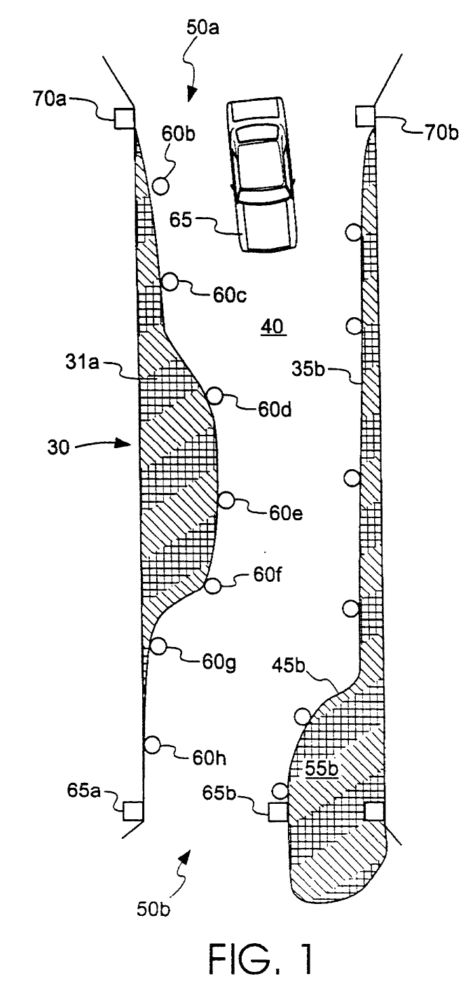

Referring now to the drawings in which a preferred embodiment of the subject invention is shown. An upper evaluation view of park area 10 is shown in FIG. 1, which park or other area includes the various and sundry obstacles that are to be maneuvered through or over in a vehicle by a participant. In this respect, the park area 10 may include any given number of separate obstacle zones 20A, 20B, 20C, 20D, 20E, 20F . . . which are to be negotiated preferably while driving a motor vehicle. Thus describing and showing a specified number of obstacles, this will not be considered as limiting the subject invention. It is important to indicate in this aspect that the various obstacle zones will generally differ from one another as to the type of specific skill or type of obstacle involved, however, this will not preclude some of the obstacle zones from being similar to one another as to the type of specific obstacle or the skill needed to negotiate a particular obstacle zone.

It is intended in this respect that the separate obstacles be spaced apart from one another any give distance so that the individual maneuvering through a particular obstacle zone 20A, 20B, 20C, 20D, 20E, 20F . . . will be able to focus again before entering each new obstacle zone. However, in this latter respect, the respective obstacle zones need not be spaced apart for purposes of implementing this invention, as some may be spaced apart while others may be juxtaposed or positioned next to each other without any spatial separation. Further, it is noted that the obstacles 20A, 20B, 20C, and 20D may be located on a surface other than the ground, such as on a platform that could be located in an amusement park or otherwise. Additionally, it is to be noted that the obstacle zones may be structured so as to be maneuvered through by any type of land-based vehicle, or in some applications of the subject invention, by boats over a water-based course.

As further seen in FIG. 1, the respective obstacle zones 20A, 20B, 20C, 20D, 20E, 20F are preferably located and positioned, particularly for purposes of facilitating leaving one obstacle zone and entry into the next obstacle zone. By this latter positioning, the individual driving a motor vehicle or other vehicle through the park course will, upon leaving one obstacle zone, be able to line up his or her vehicle for entering the next succeeding obstacle zone. It is not intended in this latter respect that the participant need go through each obstacle zone, as any arbitrary array of obstacle zones may be entered for this purpose. In one embodiment, however, it is contemplated for competitive scoring purposes that the individual or group participants maneuver through a complete set series of obstacle zones 20A, 20B, 20C, 20D, 20E, 20F . . . so that the competitive scoring will have a standard for comparative purposes.

It is stressed in this latter respect that any number or combination of the obstacle zones 20A, 20B, 20C, 20D, 20E, 20F . . . may be to have different courses that can be maneuvered by participants. Scoring standards will be had for each such different course to be maneuvered, and thus designations and maps can be provided for each different course to be maneuvered. For example, one course could be from obstacle zone A to obstacle zone C to obstacle zone D. Yet another aspect of negotiating the obstacle zones is that the obstacle zones may, for some participants, be negotiated in a random or arbitrary manner, generally for non-scoring purposes. However, this randomness may be projected into a scoring mode by having scoring bases and comparisons for any arbitrary array of obstacle zones 20A, 20B, 20C, 20D, 20E, 20F . . . Relative to the latter discussion, an example of a course to be maneuvered is seen in FIG. 1A.

Attention is now directed to FIG. 1 of the drawings in which is shown one example of a specific obstacle zone to be maneuvered. Before describing this course, it is significant to understand that obstacle zone 30 shown in FIG. 1 is only set forth as an example of such an obstacle zones of the entire contemplated array of obstacle of an obstacle zones involved.

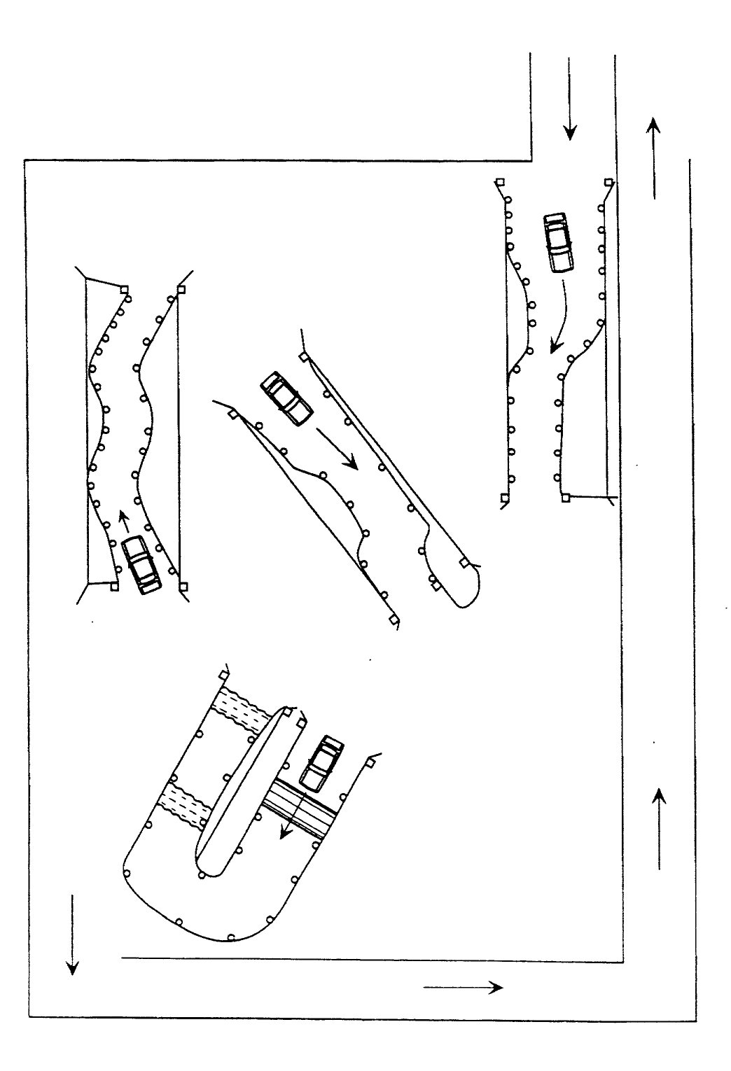

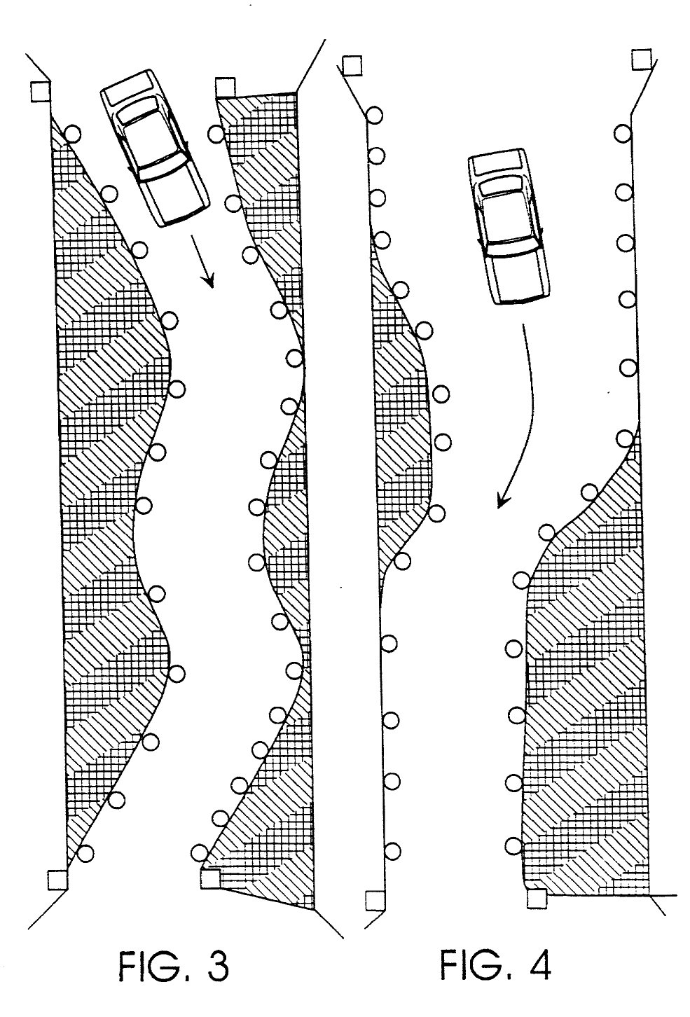

For example, the obstacle zone 30 shown in FIG. 2 can be configured and constructed as seen from the upper planar elevational view shown in FIG. 2. As seen, obstacle zone 30 comprises a restricted course for driving a motor vehicle or other vehicle there through in such a manner so that the operator will endeavor to skillfully negotiate the roadway through the obstacle zone without contacting any obstacles. More specifically, the specific obstacle zone 30 can be optionally provided with lateral entrance barriers 35A and 35B. These lateral barriers function to define the outer limits of this particular obstacle zone. These lateral entrance barriers 35A, and 35B, can be fences, posts, walls, or simply no barrier as long as the entrance or more specifically the entranceway 35 obstacle zone is somehow defined by lateral limits. In some instances, the roadway 40 that extends through the obstacle zone 20B or any obstacle zone, may itself define the lateral limits of the obstacle zone. The obstacle zone 30 has a roadway 40 therefrom such roadway extending from an entrance 50A of the obstacle zone to the exit 50B. This roadway 40 may be straight or it may be curved in part for testing the skill of the driver. The areas of the obstacle zone 30 that are not covered by a roadway are off limit areas 35A and 35B along with lateral sides which the driver must avoid to successfully negotiate the obstacle zones.

As thus can be surmised, the roadway, in any obstacle zone, will be ideally configured in a manner to require the driver to maneuver his or her vehicle through relatively sharp turns for testing the driver's skill. Other characteristics of roadway in a given obstacle zone may include in addition turns, hills, water courses, variant hardness of road conditions or other variations to cause the roadway to have some difficulties for maneuvering purposes. Not all these variations are demonstrated in the drawings or specifically described herein, as any variations and combinations thereof can be used on a given road in an obstacle zone.

To ascertain the degree of skill in maneuvering through obstacle course 30, as shown, contact members 60A, 60B, 60C, 60D, 60E, 60F, 60G, 60H are positioned strategically along the lateral edges 45A and 45B of the roadway 40. The exact number and positioning of the contact members may vary from that shown in FIG. 2 and for this purpose is in arbitrary arrangement. Therefore, numbered positioning of these contact members is not critical.

The contact members 60A, 60B, 60C, 60D, 60E, 60F, 60G, 60H are positioned as stated long the edge of the roadway 40, and are members that are intended to receive and register mechanically, and thence electrically or electronically any impact of a given motor vehicle, such as motor vehicle 75 shown in outline form in FIG. 1. Alternately stated, the driver of motor vehicle 75 will drive and maneuver the motor vehicle in such a manner to traverse roadway 40 in obstacle zone 30 in such a manner so as to avoid contacting any of the numerous contact members while traversing the road. Specifically, when a contact member 60A, 60B . . . 60H is touched by a motor vehicle as it transverses on the road 40, the contacting encounter will be sensed by the particular contact members. Each contacting encounter of a motor vehicle with any one of the contact members will be registered as a negative point or negative points assigned, depending on the location of the specific contact member 60A . . . 60H. For instance, a contact member that is positioned along a straight portion of the roadway may lead to greater negative points than one, compared to disposed along a tight curve. This latter aspect may be arbitrary, however, and there is no definitive or exacting point arrangement that limits or defines the scope of the invention herein.

It is also important to note that the various contact members 60A, 60B . . . 60H are preferably comprised of a rubber-like substance on their outer surface, so that they will not damage the motor vehicle. However, other soft or relatively soft compositions may be used.

Thus, as can be seen in an overall fashion, the obstacle zone 30 to be maneuvered will require that the driver travel the roadway 40 so as to avoid contacting as few as possible of the contact members 60A, 60B . . . 60H as possible. By so doing, the negative points will be lessened and the fewer negative points, the better the score for the driver. A conversion system of any type can be used to convert negative points on the contact members to a positive score. As an example, a score of one thousand may be given for not contacting any contact members 60A, 60B . . . 60H over the entire array of obstacle zones used in a given overall movement and greater the number of contact by the driver subtracted from the 1000 standard score. This 1000 standard score would be the inverse number of all the negative contact points that could be potentially received on a given course. Thus, if for instance a course has numerous obstacle zones having an overall sum of one thousand potential contact points. A driver who contacts six hundred contact members for six hundred negative points would receive a score of positive four hundred. This latter scoring aspect would be optional, as any other system of scoring covered be used in this respect.

At this point, it is important to emphasize and discuss a salient and obvious aspect of the process of maneuvering a vehicle through a given obstacle zone. For example, in the obstacle zone 30 shown in FIG. 1, when a driver enters the obstacle zone at entrance point 50A and drives to exit point 50B, he or she will generally be able to successfully make the passage without much or any touching of the contact members, if the driver proceeds a relatively slower through the course. This aspect is most obvious. As a result, placed at each or one side of the entranceway 50A are timers or speed sensors 70A and/or 70B. Correspondingly placed at opposing sides of the exit point are time sensors or speed sensors 65A and /or 65B. By positioning such sensors, as stated, the time it takes to traverse from the entrance point 50A to the exit point 50B will be recorded and the speed calculated accordingly dependent on the length of the roadway 40 through the obstacle course 30. Such times sensor or sensors could be correspondingly placed on each obstacle zone.

But this feature, the speed of the vehicle is recorded and it can be factored into the scoring aspect in a potential inverse mathematical relationship, among others, depending on such speed as follows:

Speed/Number of negative contact points contacted=Relative/Score

In other words, the greater the speed, the greater will be the score for a given number of contact members contacted. Consequently, if a driver moves through the distance zone at a speed often miles per hour and hits a contact member carrying a negative twenty (20) points, the driver will receive a negative two (2) contact points as seen in the following:

10/20 (speed)=1/2 points

On the other hand, if another driver hits the same contact member at speed of 40 miles per hour, his or her score points will be calculated proportionately a follows:

40/20 =2.0 points

In order to calculate speed through a given obstacle zone, as stated above there is provided at the entrance to each obstacle zone 20A, 20B, 20C, 20D, 20E, 2F . . . a sensing device which triggers a timing device to initiate a timing sequence for a given driver to drive through such particular obstacle zone. At the exit end of the obstacle zone is a second timing device which activates to signal the end of the drive through such obstacle zone. The respective sensing devices discussed and above are interconnected to a computer not shown which receives the respective entrance and exit times from the sensing device and computes and registers the speed of the driver through the obstacle zone, given the driving distances through the obstacle zone. As discussed, the speed through the obstacle zone by a given driver will yield an input factor relative to scoring a driver.

For purposes of activating the timing device, it is optimal that the entry timing mechanism be comprised to two opposing members aligned to each other along an imaginary line A-A defining the entrance to the particular obstacle zone. A lower powered laser beam or photoelectric beam can be interrupted by a portable transmitter which is activated through the photoelectric beam. This triggers the timing device accordingly. The same process is initiated on the exit.

The timing sequence can be either stored in the receiver/computer on the vehicle and store therein or relayed through the respective timers to a central computer. Other processing means can be used other than that described above.

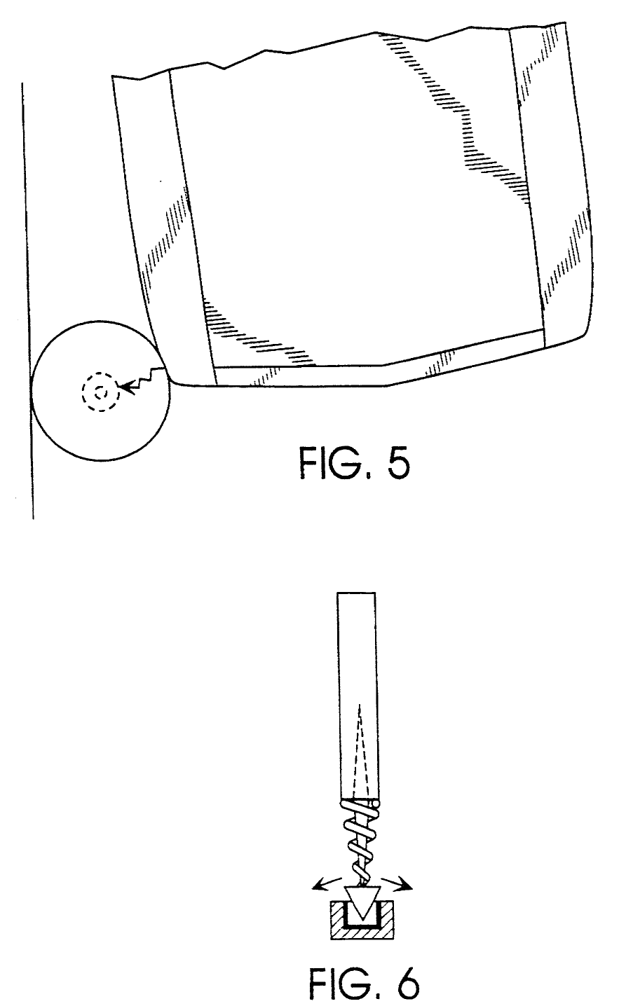

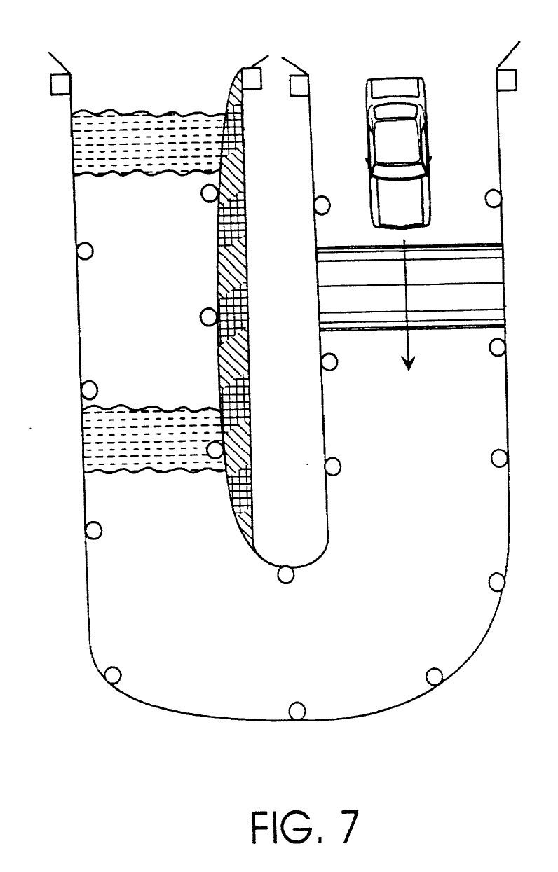

Attention is addressed to FIGS. 5 and 6 of the drawings. Shown in detail is an example of a contact member 60 that is used in conjunction with the subject invention. The following described structure is only one of the several embodiments used for a contact device that can be used in conjunction with the concepts herein.

Specifically as seen in the drawings contact member 60 is used as an example of how all the contact members can be structured. As seen in the drawings the contact member 60 is formed as having a rounded outer cylindrical surface 700 preferably been formed of a comparatively soft, pliable material such as sponge, rubber, soft plastic, fabric or any substance that will not cause damage to a vehicle upon impact. As can be seen in FIG. 5 and 6, the center of the contact member is a rigid, vertically upright support member 720 that forms the interior of the contact member 60 and which is the support mechanism of the outer soft covering, as discussed above.

The vertical support post 720 has a lower longitudinally extending secondary support bar 740 which is partially embedded, on its upper part inside the vertical 740 support member 740. As can be seen from the drawings the lower secondary support bar is coaxially supported in a conformingly shaped coil spring member 760 that is placed just immediately around the outer surface of the lower secondary support bar 740. The bottom of the spring member 760 and the bottom of the secondary support member 740 and at their respective bottom portions are embedded together in a cone shaped electrical contact member 800 which is flexibly anchored in the bottom of a cylinder chamber 820 comprised of an electrically conductive material that when contacted or touched by any part of the contact member 800 will result in an electrical signal that is translated into a score representation for scoring purposes. This electrical signal can optimally relay to a computer for scoring purposes.

As seen in FIG. 6 the contact member 800 is placed so that when the vertical support post and the secondary auxially support base are aligned vertically upright relative to the ground, there is no touching or contact between the contact member 800 and the cylind coil chamber 820. Thus, in such upright position, without such contact no electrical signal is transmitted for a negative score and it is only when the contact member 60 is pushed in one direction or another that any such contact occurs.

As seen in FIG. 8 a field 900 is shown which can include and hold several obstacle zones 20A, 20B, 20C . . . as described. Shown thereon is an entranceway 910 to drive into the field 900, and any number of addition obstacles. Once the courses intended are completed, the driver can exit at any point such as point 930 and drive back along road 960 to a point near the entranceway. This latter layout is optional however.

1. An obstacle course with a roadway for testing driving skills of a vehicle operation comprising:
A a roadway in such obstacle course;
B movable contact members position on or adjacent to the roadway, with said contact members, having means to record electrically any impact against a contact member when a vehicle hits a contact member;
C speed tabulation means affixed near said roadway to calculate the driver's vehicle speed through said roadway;
D computer calculation means associated with said contact member and said speed tabulation means to register a driver's score through the obstacle course based on a direct function of speed an inverse function of the number of the obstacles contacted.
